(19) United States
(12) Patent Application Publication
(10) Pub. No.: US 2023/0411592 A1
(43) Pub. Date: Dec. 21, 2023

(54) NEGATIVE ELECTRODE FOR SECONDARY BATTERY, AND SECONDARY BATTERY

(71) Applicant: MURATA MANUFACTURING CO., LTD., Kyoto (JP)

(72) Inventor: Yuki YOSHIMURA, Kyoto (JP)

(21) Appl. No.: 18/239,481

(22) Filed: Aug. 29, 2023

Related U.S. Application Data
(63) Continuation of application No. PCT/JP2022/007289, filed on Feb. 22, 2022.

(30) Foreign Application Priority Data
Mar. 11, 2021 (JP) 2021-039016

(51) Int. Cl. H01M 4/133; H01M 10/0525; H01M 4/587; H01M 4/134

(52) U.S. Cl. CPC H01M 4/133; H01M 10/0525; H01M 4/587; H01M 4/134; H01M 2004/027

(57) ABSTRACT

A secondary battery includes a positive electrode, a negative electrode, and an electrolytic solution. The negative electrode includes an inorganic metal salt and an organic fiber compound.

### CROSS REFERENCE TO RELATED APPLICATIONS

The present application is a continuation of PCT patent application no. PCT/JP2022/007289, filed on Feb. 22, 2022, which claims priority to Japanese patent application no. 2021-039016, filed on Mar. 11, 2021, the entire contents of which are incorporated herein by reference.

### BACKGROUND

The present technology relates to a negative electrode for a secondary battery, and a secondary battery.

Various kinds of electronic equipment, including mobile phones, have been widely used. Such widespread use has promoted development of a secondary battery as a power source that is smaller in size and lighter in weight and has a higher energy density. The secondary battery includes a positive electrode, a negative electrode (a negative electrode for a secondary battery), and an electrolytic solution. A configuration of the secondary battery has been considered in various ways.

For example, to suppress an increase in an internal resistance, cellulose fiber is used as a binder that binds electrode active material particles.

### SUMMARY

The present technology relates to a negative electrode for a secondary battery, and a secondary battery.

Although consideration has been given in various ways regarding a battery characteristic of a secondary battery, a cyclability characteristic and an electric resistance characteristic of the secondary battery are not sufficient yet. Accordingly, there is room for improvement in terms thereof.

It is therefore desirable to provide a negative electrode for a secondary battery, and a secondary battery that each make it possible to achieve a superior cyclability characteristic and a superior electric resistance characteristic.

A negative electrode for a secondary battery according to an embodiment of the present technology includes an inorganic metal salt and an organic fiber compound.

A secondary battery according to an embodiment of the present technology includes a positive electrode, a negative electrode, and an electrolytic solution. The negative electrode has a configuration similar to the configuration of the negative electrode for a secondary battery according to an embodiment of the present technology described above.

According to the negative electrode for a secondary battery or the secondary battery of an embodiment of the present technology, the negative electrode for a secondary battery includes the inorganic metal salt and the organic fiber compound. Accordingly, it is possible to achieve a superior cyclability characteristic and a superior electric resistance characteristic.

Note that effects of the present technology are not necessarily limited to those described herein and may include any of a series of suitable effects described in relation to the present technology.

### BRIEF DESCRIPTION OF THE FIGURES

FIG. 1 is a sectional view of a configuration of a negative electrode for a secondary battery according to an embodiment of the present technology.

FIG. 2 is an enlarged sectional view of a configuration of a negative electrode active material particle in a negative electrode for a secondary battery according to an embodiment of the present technology.

FIG. 3 is a perspective view of a configuration of a secondary battery according to an embodiment of the present technology.

FIG. 4 is a sectional view of a configuration of a battery device illustrated in FIG.

FIG. 5 is a block diagram illustrating a configuration of an application example of the secondary battery.

### DETAILED DESCRIPTION

One or more embodiments of the present technology are described below in further detail including with reference to the drawings.

A description is given first of a negative electrode for a secondary battery (hereinafter, simply referred to as a “negative electrode”) according to a an embodiment of the present technology.

The negative electrode is to be used in a secondary battery, which is an electrochemical device. However, the negative electrode may be used in electrochemical devices other than a secondary battery. Other electrochemical devices are not particularly limited in kind, and specific examples thereof include a capacitor.

Furthermore, in the electrochemical device such as the above-mentioned secondary battery, an electrode reactant is to be inserted into and extracted from the negative electrode upon an electrode reaction. The electrode reactant is not particularly limited in kind, and specific examples thereof include a light metal such as an alkali metal or an alkaline earth metal. Examples of the alkali metal include lithium, sodium, and potassium. Examples of the alkaline earth metal include beryllium, magnesium, and calcium.

Examples are given below of a case where the electrode reactant is lithium. That is, lithium is inserted into and extracted from the negative electrode upon an electrode reaction. In this case, lithium is inserted and extracted in an ionic state.

FIG. 1 illustrates a sectional configuration of the negative electrode according to an embodiment.

The negative electrode includes an inorganic metal salt and an organic fiber compound. More specifically, as illustrated in FIG. 1, the negative electrode includes a negative electrode current collector 110 and a negative electrode active material layer 120. The negative electrode active material layer 120 includes the inorganic metal salt and the organic fiber compound, which are mentioned above. In this case, the inorganic metal salt and the organic fiber compound are each dispersed in the negative electrode active material layer 120.

A reason why the negative electrode, or more specifically, the negative electrode active material layer 120 includes the inorganic metal salt and the organic fiber compound, and the inorganic metal salt and the organic fiber compound are each dispersed in the negative electrode active material layer 120 is that the secondary battery including such a negative electrode suppresses an increase in an electric resistance and decomposition of the electrolytic solution while securing ion conductivity of lithium.

In more detail, in a case where the negative electrode active material layer 120 includes both the inorganic metal salt and the organic fiber compound, the inorganic metal salt having electrical conductivity is disposed on a surface of a negative electrode active material to be described later, and the organic fiber compound having a porous structure covers the surface of the negative electrode active material in the negative electrode active material layer 120. Thus, the surface of the negative electrode active material is electrochemically protected by the organic fiber compound while it is ensured that the ion conductivity (a transfer path of lithium) is provided using the porous structure. This suppresses a decomposition reaction of the electrolytic solution on the surface of the electrode reactant having reactivity while securing smooth insertion and extraction of lithium. Furthermore, the electron conductivity between the negative electrode active materials is improved using the electrical conductivity of the inorganic metal salt. This suppresses an increase in the electric resistance.

This secures the ion conductivity of lithium and suppresses each of an increase in the electric resistance and the decomposition of the electrolytic solution compared with a case in which the negative electrode active material layer 120 includes only one of the inorganic metal salt or the organic fiber compound.

The negative electrode current collector 110 has two opposed surfaces on each of which the negative electrode active material layer 120 is to be provided. The negative electrode current collector 110 includes one or more of electrically conductive materials including, without limitation, a metal material. Examples of the metal material include copper, aluminum, nickel, and stainless steel. Note that the negative electrode current collector 110 may include a single layer or multiple layers.

The surface of the negative electrode current collector 110 is preferably roughened by a method such as an electrolytic method. A reason for this is that the adherence of the negative electrode active material layer 120 to the negative electrode current collector 110 is improved using what is called an anchor effect. Note, however, that the negative electrode current collector 110 may be omitted.

The negative electrode active material layer 120 includes the above-mentioned inorganic metal salt and the organic fiber compound together with the negative electrode active material into which lithium is insertable and from which lithium is extractable.

The negative electrode active material layer 120 is provided on each of the two opposed surfaces of the negative electrode current collector 110. Note, however, that the negative electrode active material layer 120 may be provided only on one of the two opposed surfaces of the negative electrode current collector 110. Note that the negative electrode active material layer 120 may further include one or more of other materials including, without limitation, a negative electrode binder and a negative electrode conductor.

A method of forming the negative electrode active material layer 120 is not particularly limited and specifically includes one or more of methods including, without limitation, a coating method, a vapor-phase method, a liquid-phase method, a thermal spraying method, and a firing (sintering) method.

The negative electrode active material is not particularly limited in kind and specifically includes one or more of materials including, without limitation, a carbon material and a metal-based material. That is, the negative electrode active material may include only the carbon material, only the metal-based material, or both of the carbon material and the metal-based material. A reason for this is that a high energy density is obtainable. However, the kind of the negative electrode active material may be any material other than the carbon material and the metal-based material.

The term “carbon material” is a generic term for a material including carbon as a constituent element. A reason for this is that a high energy density is stably obtainable owing to a crystal structure of the carbon material that hardly varies upon insertion and extraction of lithium. Another reason is that improved electrical conductivity of the negative electrode active material layer 120 is achievable owing to the carbon material that also serves as the negative electrode conductor.

Specific examples of the carbon material include graphitizable carbon, non-graphitizable carbon, and graphite (natural graphite and artificial graphite). Spacing of a (002) plane of the non-graphitizable carbon is not particularly limited, but specifically, is preferably greater than or equal to 0.37 nm. Spacing of a (002) plane of the graphite is not particularly limited, but specifically, is preferably smaller than or equal to 0.34 nm.

More specific examples of the carbon material include pyrolytic carbons, cokes, glassy carbon fibers, an organic polymer compound fired body, activated carbon, and carbon blacks. Examples of the cokes include pitch coke, needle coke, and petroleum coke. The organic polymer compound fired body is a resultant of firing or carbonizing a polymer compound such as a phenol resin or a furan resin at an appropriate temperature. Other than the above, the carbon material may be low-crystalline carbon subjected to heat treatment at a temperature of about 1000° C. or lower, or may be amorphous carbon. The carbon material is not particularly limited in shape, and specific examples thereof include one or more shapes including, without limitation, a fibrous shape, a spherical shape, a granular shape, or a flaky shape.

The term “metal-based material” is a generic term for a material that includes, as one or more constituent elements, one or more elements among metal elements and metalloid elements that are each able to form an alloy with lithium. A reason for this is that a higher energy density is obtainable.

The metal-based material may be a simple substance, an alloy, a compound, a mixture of two or more thereof, or a material including one or more phases thereof. The “simple substance” described here merely refers to a simple substance in a general sense. The simple substance may therefore include a small amount of impurity. That is, the purity of the simple substance does not necessarily have to be 100%.

Note, however, that the term “alloy” described here includes not only a material including two or more metal elements, but also a material including one or more metal elements and one or more metalloid elements. Additionally, the term “alloy” may further include one or more non-metallic elements. The metal-based material is not particularly limited in state, but specifically includes one or more states including, without limitation, a solid solution, a eutectic (a eutectic mixture), an intermetallic compound, or a state including two or more thereof that coexist.

Specific examples of the metal element and the metalloid element include magnesium, boron, aluminum, gallium, indium, silicon, germanium, tin, lead, bismuth, cadmium, silver, zinc, hafnium, zirconium, yttrium, palladium, and platinum.

Among these elements, silicon is preferable. A reason for this is that a markedly high energy density is obtainable owing to superior lithium insertability and superior lithium extractability of silicon.

The silicon alloy includes one or more of metal elements including, without limitation, tin, nickel, copper, iron, cobalt, manganese, zinc, indium, silver, titanium, germanium, bismuth, antimony, and chromium as one or more constituent elements other than silicon. The silicon compound includes one or more of non-metallic elements including, without limitation, carbon and oxygen as one or more constituent elements other than silicon. Note, however, that the silicon compound may include, as one or more constituent elements other than silicon, one or more of the series of metal elements described in relation to the silicon alloy.

Specific examples of the silicon alloy include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, and SiC. Note, however, that the composition of the silicon alloy (a mixture ratio of silicon and the metal element) may be changed as desired.

Specific examples of the silicon compound include Si₃N₄, Si₂N₂O, SiOᵥ (where 0<v≤2), and LiSiO. Note, however, that a range of “v” may be 0.2<v<1.4, in one example.

In particular, the negative electrode active material preferably includes both the carbon material and the metal-based material for the reasons described below.

While the metal-based material, in particular, a material including silicon as a constituent element has an advantage of having a high theoretical capacity, there is a concern that it easily expands and contracts greatly upon charging and discharging. While there is a concern that the carbon material has a low theoretical capacity, the carbon material has an advantage that it resists expanding and contracting upon charging and discharging. Thus, the combined use of the carbon material and the metal-based material suppresses expanding and contracting of the negative electrode active material layer 120 upon charging and discharging while achieving a high theoretical capacity (that is, a high battery capacity).

The inorganic metal salt is a compound resulting from substituting a hydrogen atom of an inorganic acid with a metal ion. Only one inorganic metal salt may be used, or two or more inorganic metal salts may be used.

The inorganic acid forming the inorganic metal salt is not particularly limited in kind, and specific examples thereof include a hydrofluoric acid, a carbonic acid, a nitric acid, a sulfuric acid, and a phosphoric acid.

The metal ion is not particularly limited in kind, and specific examples thereof include an alkali metal ion. Specific examples of the alkali metal ion include a lithium ion, a sodium ion, and a potassium ion. In particular, in a case where the electrode reactant is lithium, the alkali metal ion is preferably a lithium ion.

Specific examples of the inorganic metal salt include lithium fluoride, which is a hydrofluoric acid lithium salt, and lithium carbonate, which is a carbonic acid lithium salt. A reason for this is that these compounds sufficiently improve the ion conductivity of lithium and sufficiently suppress each of an increase in the electric resistance and the decomposition of the electrolytic solution.

The organic fiber compound is a fibrous polymer compound (carbohydrate) and may include, as one or more constituent elements, one or more of non-carbon elements including, without limitation, nitrogen. Only one organic fiber compound may be used, or two or more organic fiber compounds may be used.

Specific examples of the organic fiber compound include cellulose, chitin, and chitosan. A reason for this is that these compounds sufficiently improve the ion conductivity of lithium and sufficiently suppress each of an increase in the electric resistance and the decomposition of the electrolytic solution.

The negative electrode binder includes one or more of materials including, without limitation, a synthetic rubber and a polymer compound. Examples of the synthetic rubber include a styrene-butadiene-based rubber, a fluorine-based rubber, and ethylene propylene diene. Examples of the polymer compound include polyvinylidene difluoride, polyimide, and carboxymethyl cellulose.

The negative electrode conductor includes one or more of electrically conductive materials including, without limitation, a carbon material. Examples of the carbon material include graphite, carbon black, acetylene black, and Ketjen black. Note, however, that the electrically conductive material may be a metal material or a polymer compound, for example.

In particular, the negative electrode conductor preferably includes a fibrous carbon material such as a carbon nanotube. A reason for this is that improved electrical conductivity between the negative electrode active materials reduces the electric resistance of the negative electrode active material layer 120.

In manufacturing the negative electrode, first, the negative electrode active material, the inorganic metal salt, and the organic fiber compound are mixed with each other to thereby obtain a negative electrode mixture. In this case, the negative electrode mixture may include, for example, the positive electrode binder or the positive electrode conductor on an as-needed basis.

Thereafter, the negative electrode mixture is put into a solvent to thereby prepare a negative electrode mixture slurry in a paste form. The solvent may be an aqueous solvent, or may be an organic solvent. In this case, the solvent may be stirred using a stirring apparatus such as a mixer.

Lastly, the negative electrode mixture slurry is applied on the two opposed surfaces of the negative electrode current collector 110 to thereby form the negative electrode active material layers 120. Thereafter, the negative electrode active material layers 120 may be compression-molded by means of, for example, a roll pressing machine. In this case, the negative electrode active material layers 120 may be heated. The negative electrode active material layers 120 may be compression-molded multiple times.

In this manner, the negative electrode active material layers 120 are formed on the respective two opposed surfaces of the negative electrode current collector 110. Thus, the negative electrode is completed.

The negative electrode of the first embodiment includes the inorganic metal salt and the organic fiber compound.

In this case, as described above, the inorganic metal salt having electrical conductivity is disposed on the surface of the negative electrode active material, and the organic fiber compound having the porous structure covers the surface of the negative electrode active material. This electrochemically protects the surface of the negative electrode active material while ensuring that the ion conductivity is provided. Accordingly, the decomposition reaction of the electrolytic solution is suppressed on the surface of the electrode reactant while the insertion and extraction of lithium is secured. Furthermore, the improved electron conductivity between the negative electrode active materials suppresses an increase in the electric resistance.

Thus, the secondary battery including the negative electrode suppresses an increase in the electric resistance and the decomposition of the electrolytic solution while securing the ion conductivity of lithium. Accordingly, it is possible to achieve a superior cyclability characteristic and a superior electric resistance characteristic.

In particular, the inorganic metal salt may include, without limitation, lithium fluoride, and the organic fiber compound may include, without limitation, cellulose. This helps to sufficiently improve the ion conductivity of lithium and to sufficiently suppress each of an increase in the electric resistance and the decomposition of the electrolytic solution. This makes it possible to achieve higher effects.

Furthermore, the negative electrode active material layer 120 may include the negative electrode active material, the inorganic metal salt, and the organic fiber compound. In this case, each of the inorganic metal salt and the organic fiber compound is dispersed in the negative electrode active material layer 120. This makes it easier for the inorganic metal salt having electrical conductivity to be disposed on the surface of the negative electrode active material and for the organic fiber compound having the porous structure to cover the surface of the negative electrode active material as described above. This makes it possible to achieve higher effects.

A description is given next of a negative electrode for a secondary battery (a negative electrode) according to another embodiment of the present technology.

The negative electrode has a configuration similar to that of the negative electrode of an embodiment described above except that the configuration of the negative electrode active material layer 120 differs. The configuration of the negative electrode is similar to that of the negative electrode of an embodiment described above except what is described below. In the following, where appropriate, reference will be made to FIG. 1 that has already been described.

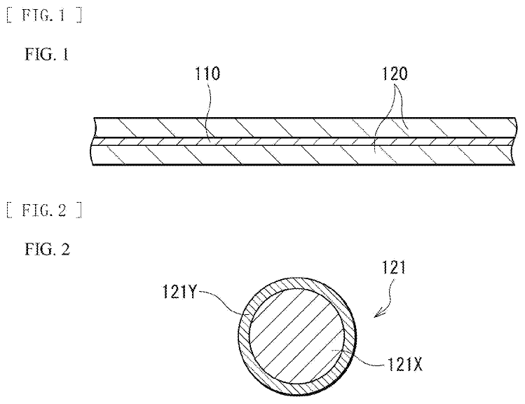

FIG. 2 illustrates an enlarged sectional configuration of a negative electrode active material particle 121 in the negative electrode according to the second embodiment. The negative electrode active material layer 120 includes the negative electrode material in particles (negative electrode active material particles 121), and the negative electrode active material particles 121 each include a center part 121X and a covering part 121Y as illustrated in FIG. 2.

The center part 121X includes one or more of materials including, without limitation, a carbon material and a metal-based material to allow for insertion and extraction of lithium. Details of each of the carbon material and the metal-based material are as described above.

The covering part 121Y includes the inorganic metal salt and the organic fiber compound. Details of each of the inorganic metal salt and the organic fiber compound are as described above. The covering part 121Y may cover the entire surface of the center part 121X, or may cover only a portion of the surface of the center part 121X. In the latter case, multiple covering parts 121Y may cover the surface of the center part 121X at respective locations separate from each other.

That is, in the second embodiment, unlike the first embodiment in which the inorganic metal salt and the organic fiber compound are each dispersed in the negative electrode active material layer 120, the inorganic metal salt and the organic fiber compound are each localized on the surface of the center part 121X.

Thus, in a case where the covering part 121Y of each of the negative electrode active material particle 121 includes the inorganic metal salt and the organic fiber compound, advantages similar to those in the first embodiment are obtainable. That is, the inorganic metal salt having electrical conductivity is disposed on the surface of the center part 121X, and the organic fiber compound having the porous structure covers the surface of the center part 121X. This improves the ion conductivity of lithium and suppresses each of an increase in the electric resistance and the decomposition of the electrolytic solution.

In this case, particularly, because the inorganic metal salt and the organic fiber compound are each localized on the surface of the center part 121X, the inorganic metal salt is more easily disposed on the surface of the center part 121X, and the organic fiber compound more easily covers the surface of the center part 121X. Thus, compared with the first embodiment in which the inorganic metal salt and the organic fiber compound are each not localized on the surface of the negative electrode active material, the ion conductivity of lithium is further improved, and an increase in the electric resistance and the decomposition of the electrolytic solution are each further suppressed.

Needless to say, the negative electrode active material layer 120 may further include one or more of other materials including, without limitation, a negative electrode binder and a negative electrode conductor. Details of each of the negative electrode binder and the negative electrode conductor are as described above.

A method of manufacturing the negative electrode is similar to the method of manufacturing the negative electrode according to an embodiment described above, except for a difference in the forming procedure of the negative electrode active material layer 120.

In forming the negative electrode active material layer 120, first, the center part 121X, the inorganic metal salt, and the organic fiber compound are mixed with each other to thereby obtain a mixture. The inorganic metal salt and the organic fiber compound are raw materials for forming the covering part 121Y. The center part 121X includes one or more of materials including, without limitation, the carbon material in a powder form and the metal-based material in a powder form. Thereafter, the mixture is put into a solvent to thereby prepare a mixed solution. The solvent may be an aqueous solvent, or may be an organic solvent. In this case, the solvent may be stirred using a stirring apparatus such as a mixer.

Thereafter, the mixed solution is sprayed using a sprayer such as a spray dryer. This forms the covering part 121Y including the inorganic metal salt and the organic fiber compound on the surface of the center part 121X. Thus, the negative electrode active material particles 121 are obtainable.

Lastly, as described above, the negative electrode active material particles 121 are used to prepare a negative electrode mixture slurry, following which the negative electrode mixture slurry is used to form the negative electrode active material layer 120.

The negative electrode includes the inorganic metal salt and the organic fiber compound. Thus, for a reason similar to that in the first embodiment, the secondary battery including the negative electrode suppresses an increase in the electric resistance and the decomposition of the electrolytic solution while securing the ion conductivity of lithium. Accordingly, it is possible to achieve a superior cyclability characteristic and a superior electric resistance characteristic.

In particular, the covering part 121Y may cover the surface of the center part 121X configured to allow insertion and extraction of lithium, and the covering part 121Y may include the inorganic metal salt and the organic fiber compound. In this case, the inorganic metal salt and the organic fiber compound are each localized on the surface of the center part 121X as described above. This helps to further improve the ion conductivity of lithium and further suppress each of an increase in the electric resistance and the decomposition of the electrolytic solution. This makes it possible to achieve higher effects.

Other action and effects of the negative electrode according to the second embodiment are similar to those of the negative electrode according to the first embodiment.

A description is given next of a secondary battery including the negative electrode described herein.

The secondary battery to be described herein is a secondary battery that obtains a battery capacity using insertion and extraction of an electrode reactant, and includes a positive electrode, a negative electrode, and an electrolytic solution. The electrolytic solution is a liquid electrolyte.

In the secondary battery, a charge capacity of the negative electrode is greater than a discharge capacity of the positive electrode. In other words, an electrochemical capacity per unit area of the negative electrode is set to be greater than an electrochemical capacity per unit area of the positive electrode. This is to prevent precipitation of the electrode reactant on the surface of the negative electrode during charging.

Details of the kinds of the electrode reactant are as described herein. Examples are given below of a case where the electrode reactant is lithium as in the description given above in relation to the negative electrode. A secondary battery that obtains a battery capacity using insertion and extraction of lithium is what is called a lithium-ion secondary battery. In the lithium-ion secondary battery, lithium is inserted and extracted in an ionic state.

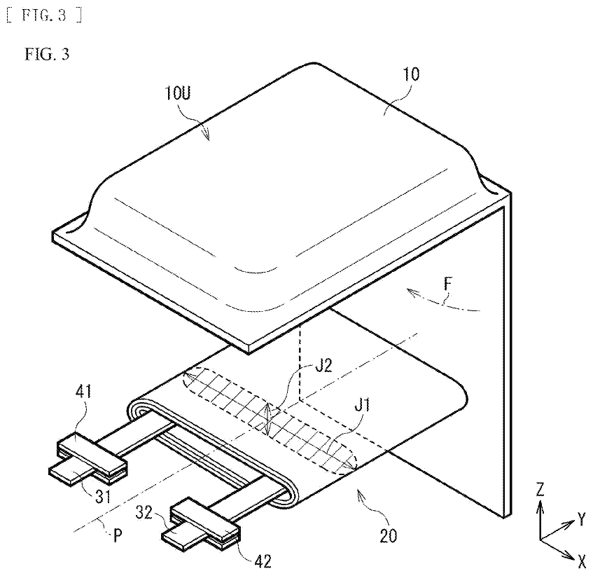

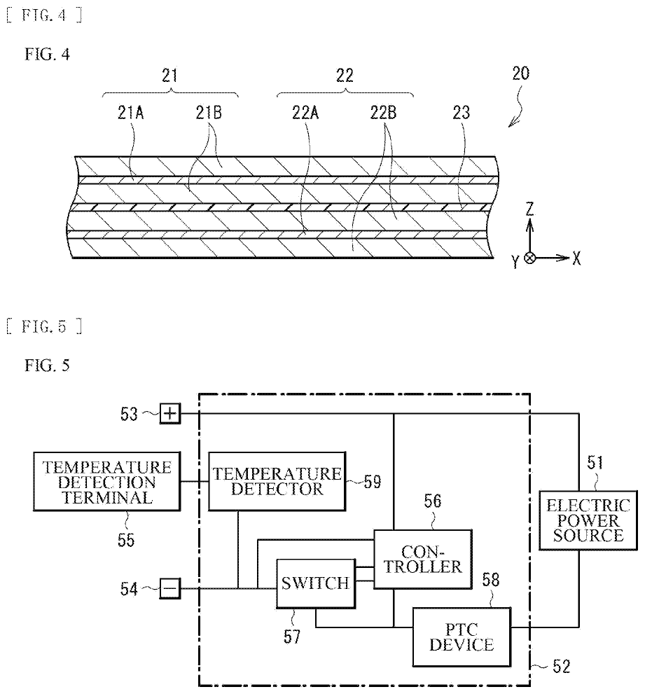

FIG. 3 illustrates a perspective configuration of the secondary battery. FIG. 4 illustrates a sectional configuration of a battery device 20 illustrated in FIG. 3. Note that FIG. 3 illustrates a state in which an outer package film 10 and the battery device 20 are separated from each other, and a section of the battery device along an XZ plane is indicated by a dashed line. FIG. 4 illustrates only a portion of the battery device 20.

As illustrated in FIGS. 3 and 4, the secondary battery includes the outer package film 10, the battery device 20, a positive electrode lead 31, a negative electrode lead 32, and sealing films 41 and 42. The secondary battery described here is a secondary battery of a laminated-film type in which the outer package film having flexibility or softness is used.

As illustrated in FIG. 3, the outer package film 10 is a flexible outer package member that contains the battery device 20. The outer package film 10 has a pouch-shaped structure in which the battery device 20 is sealed in a state of being contained inside the outer package film 10. The outer package film 10 thus contains a positive electrode 21, a negative electrode 22, and an electrolytic solution that are to be described later.

Here, the outer package film 10 is a single film-shaped member and is folded toward a folding direction F. The outer package film 10 has a depression part to place the battery device 20 therein. The depression part 10U is what is called a deep drawn part.

Specifically, the outer package film 10 is a laminated film including three layers, which are a fusion-bonding layer, a metal layer, and a surface protective layer stacked in this order from an inner side. In a state in which the outer package film is folded, outer edge parts of the fusion-bonding layer opposed to each other are fusion-bonded to each other. The fusion-bonding layer includes a polymer compound such as polypropylene. The metal layer includes a metal material such as aluminum. The surface protective layer includes a polymer compound such as nylon.

Note that the outer package film 10 is not particularly limited in configuration or the number of layers, and may be single-layered or two-layered, or may include four or more layers.

The sealing film 41 is interposed between the outer package film 10 and the positive electrode lead 31. The sealing film 42 is interposed between the outer package film 10 and the negative electrode lead 32. Note that the sealing film 41, the sealing film 42, or both may be omitted.

The sealing film 41 is a sealing member that prevents entry, for example, of outside air into the outer package film 10. The sealing film 41 includes a polymer compound such as a polyolefin that has adherence to the positive electrode lead 31. Examples of the polyolefin include polypropylene.

A configuration of the sealing film 42 is similar to that of the sealing film 41 except that the sealing film 42 is a sealing member that has adherence to the negative electrode lead 32. That is, the sealing film 42 includes a polymer compound such as a polyolefin that has adherence to the negative electrode lead 32.

As illustrated in FIGS. 3 and 4, the battery device 20 is a power generation device that includes the positive electrode 21, the negative electrode 22, a separator 23, and the electrolytic solution (not illustrated). The battery device 20 is contained inside the outer package film 10.

The battery device 20 is what is called a wound electrode body. That is, in the battery device 20, the positive electrode 21 and the negative electrode 22 are stacked on each other with the separator 23 interposed therebetween, and the positive electrode 21, the negative electrode 22, and the separator 23 are wound about a winding axis P. The winding axis P is a virtual axis extending in a Y-axis direction. Thus, the positive electrode 21 and the negative electrode 22 are opposed to each other with the separator 23 interposed therebetween, and are wound.

A three-dimensional shape of the battery device 20 is not particularly limited. Here, the battery device 20 has an elongated shape. Accordingly, a section of the battery device 20 intersecting the winding axis P, that is, a section of the battery device 20 along the XZ plane, has an elongated shape defined by a major axis J1 and a minor axis J2. The major axis J1 is a virtual axis that extends in an X-axis direction and has a larger length than the minor axis J2. The minor axis J2 is a virtual axis that extends in a Z-axis direction intersecting the X-axis direction and has a smaller length than the major axis J1. Here, the battery device 20 has an elongated cylindrical three-dimensional shape. Thus, the section of the battery device 20 has an elongated, substantially elliptical shape.

The positive electrode 21 includes, as illustrated in FIG. 4, a positive electrode current collector 21A and a positive electrode active material layer 21B.

The positive electrode current collector 21A has two opposed surfaces on each of which the positive electrode active material layer 21B is to be provided. The positive electrode current collector 21A includes an electrically conductive material such as a metal material. Examples of the metal material include aluminum.

Here, the positive electrode active material layer 21B is provided on each of the two opposed surfaces of the positive electrode current collector 21A. The positive electrode active material layer 21B includes one or more of positive electrode active materials into which lithium is insertable and from which lithium is extractable. Note that the positive electrode active material layer 21B may be provided only on one of the two opposed surfaces of the positive electrode current collector 21A on a side where the positive electrode 21 is opposed to the negative electrode 22. Further, the positive electrode active material layer 21B may further include one or more of other materials including, without limitation, a positive electrode binder and a positive electrode conductor. A method of forming the positive electrode active material layer 21B is not particularly limited and specifically includes one or more of methods including, without limitation, a coating method.

The positive electrode active material is not particularly limited in kind, and specific examples thereof include a lithium-containing compound. The lithium-containing compound is a compound including lithium and one or more transition metal elements as constituent elements. The lithium-containing compound may further include one or more other elements as one or more constituent elements. The one or more other elements are not particularly limited in kind as long as the one or more other elements are each an element other than lithium and the transition metal elements. Specifically, the one or more other elements are any one or more of elements belonging to groups 2 to 15 in the long period periodic table of elements. The lithium-containing compound is not particularly limited in kind, and is specifically an oxide, a phosphoric acid compound, a silicic acid compound, or a boric acid compound, for example.

Specific examples of the oxide include LiNiO₂, LiCoO₂, LiCo_{0.98}Al_{0.01}Mg_{0.01}O₂, LiNi_{0.5} Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15}(Mn_{0.65}Ni_{0.22}Co_{0.13})O₂, and LiMn₂O₄. Specific examples of the phosphoric acid compound include LiFePO₄, LiMnPO₄, LiFe_{0.5}Mn_{0.5}PO₄, and LiFe_{0.3}Mn_{0.7}PO₄.

Details of the positive electrode binder are similar to those of the negative electrode binder described above. Details of the positive electrode conductor are similar to those of the negative electrode conductor described above.

The configuration of the negative electrode 22 is similar to that of the negative electrode described above. That is, the negative electrode 22 includes the inorganic metal salt and the organic fiber compound. More specifically, the negative electrode 22 includes, as illustrated in FIG. 4, a negative electrode current collector 22A corresponding to the negative electrode current collector 110 and a negative electrode active material layer 22B corresponding to the negative electrode active material layer 120.

The negative electrode 22 may have a configuration similar to that of the negative electrode of the first embodiment or may have a configuration similar to that of the negative electrode of the second embodiment.

As illustrated in FIG. 4, the separator 23 is an insulating porous film interposed between the positive electrode 21 and the negative electrode 22 and allows lithium ions to pass therethrough while preventing contact (a short circuit) between the positive electrode 21 and the negative electrode 22. The separator 23 includes a polymer compound such as polyethylene.

The positive electrode 21, the negative electrode 22, and the separator 23 are each impregnated with the electrolytic solution. The electrolytic solution includes a solvent and an electrolyte salt.

The solvent includes one or more of non-aqueous solvents (organic solvents), and the electrolytic solution including the non-aqueous solvent(s) is what is called a non-aqueous electrolytic solution. The non-aqueous solvent is, for example, an ester or an ether, more specifically, a carbonic-acid-ester-based compound, a carboxylic-acid-ester-based compound, or a lactone-based compound, for example. A reason for this is that a dissociation property of the electrolyte salt and mobility of ions improve.

The carbonic-acid-ester-based compound is a cyclic carbonic acid ester or a chain carbonic acid ester. Specific examples of the cyclic carbonic acid ester include ethylene carbonate and propylene carbonate, and specific examples of the chain carbonic acid ester include dimethyl carbonate, diethyl carbonate, and ethyl methyl carbonate.

The carboxylic-acid-ester-based compound is a chain carboxylic acid ester, for example. Specific examples of the chain carboxylic acid ester include ethyl acetate, ethyl propionate, propyl propionate, and ethyl trimethylacetate.

The lactone-based compound is a lactone, for example. Specific examples of the lactone include γ-butyrolactone and γ-valerolactone.

Note that the ether may be the lactone-based compound described above, 1,2-dimethoxyethane, tetrahydrofuran, 1,3-dioxolane, or 1,4-dioxane, for example.

In particular, the solvent preferably includes the chain carboxylic acid ester. A reason for this is that this further suppresses an increase in the electric resistance and further suppresses the decomposition reaction of the electrolytic solution.

The electrolyte salt includes one or more of light metal salts including, without limitation, a lithium salt. Specific examples of the lithium salt include lithium hexafluorophosphate (LiPF₆), lithium tetrafluoroborate (LiBF₄), lithium trifluoromethanesulfonate (LiCF₃SO₃), lithium bis(fluoro sulfonyl)imide (LiN(FSO₂)₂), lithium bis(trifluoromethanesulfonyl)imide (LiN(CF₃SO₂)₂), lithium tris(trifluoromethanesulfonyl)methide (LiC(CF₃SO₂)₃), lithium bis(oxalato)borate (LiB(C₂O₄)₂), lithium monofluorophosphate (Li₂PFO₃), and lithium difluorophosphate (LiPF₂O₂). A reason for this is that a high battery capacity is obtainable.

In particular, the electrolyte salt preferably includes lithium monofluorophosphate, lithium difluorophosphate, or both. A reason for this is that this further suppresses an increase in the electric resistance and further suppresses the decomposition reaction of the electrolytic solution.

A content of the electrolyte salt is not particularly limited and is specifically within a range from 0.3 mol/kg to 3.0 mol/kg both inclusive with respect to the solvent. A reason for this is that high ion conductivity is obtainable.

Note that the electrolytic solution may further include one or more of additives. The additives are not particularly limited in kind, and specific examples include an unsaturated cyclic carbonic acid ester, a halogenated cyclic carbonic acid ester, a sulfonic acid ester, a phosphoric acid ester, an acid anhydride, a nitrile compound, and an isocyanate compound.

Specific examples of the unsaturated cyclic carbonic acid ester include vinylene carbonate, vinyl ethylene carbonate, and methylene ethylene carbonate. Specific examples of the halogenated cyclic carbonic acid ester include monofluoroethylene carbonate and difluoroethylene carbonate. Specific examples of the sulfonic acid ester include propane sultone and propene sultone. Specific examples of the phosphoric acid ester include trimethyl phosphate and triethyl phosphate. Specific examples of the acid anhydride include succinic anhydride, 1,2-ethane disulfonic anhydride, and 2-sulfobenzoic anhydride. Specific examples of the nitrile compound include succinonitrile. Specific examples of the isocyanate compound include hexamethylene diisocyanate.

As illustrated in FIG. 3, the positive electrode lead 31 is a positive electrode terminal coupled to the positive electrode 21. More specifically, the positive electrode lead 31 is coupled to the positive electrode current collector 21A. The positive electrode lead 31 is led from an inside to an outside of the outer package film 10. The positive electrode lead 31 includes an electrically conductive material such as aluminum. The positive electrode lead 31 is not particularly limited in shape, and specifically has any of shapes including, without limitation, a thin plate shape and a meshed shape.

As illustrated in FIG. 3, the negative electrode lead 32 is a negative electrode terminal coupled to the negative electrode 22. More specifically, the negative electrode lead 32 is coupled to the negative electrode current collector 22A. The negative electrode lead 32 is led from the inside to the outside of the outer package film 10. The negative electrode lead 32 includes an electrically conductive material such as copper. Here, the negative electrode lead 32 is led in a direction similar to that in which the positive electrode lead 31 is led out. Note that details of a shape of the negative electrode lead 32 are similar to those of the shape of the positive electrode lead 31.

Upon charging the secondary battery, in the battery device 20, lithium is extracted from the positive electrode 21, and the extracted lithium is inserted into the negative electrode 22 via the electrolytic solution. Upon discharging the secondary battery, in the battery device 20, lithium is extracted from the negative electrode 22, and the extracted lithium is inserted into the positive electrode 21 via the electrolytic solution. Upon charging and discharging, lithium is inserted and extracted in an ionic state.

In a case of manufacturing the secondary battery, the positive electrode 21 and the negative electrode 22 are fabricated, following which the secondary battery is fabricated using the positive electrode 21, the negative electrode 22, and the electrolytic solution, according to a procedure to be described below.

First, a mixture (a positive electrode mixture) in which the positive electrode active material, the positive electrode binder, and the positive electrode conductor are mixed with each other is put into a solvent to thereby prepare a positive electrode mixture slurry in a paste form. The solvent may be an aqueous solvent, or may be an organic solvent. Thereafter, the positive electrode mixture slurry is applied on the two opposed surfaces of the positive electrode current collector 21A to thereby form the positive electrode active material layers 21B. Thereafter, the positive electrode active material layers 21B may be compression-molded by means of, for example, a roll pressing machine. In this case, the positive electrode active material layers 21B may be heated. The positive electrode active material layers 21B may be compression-molded multiple times. In this manner, the positive electrode active material layers 21B are formed on the respective two opposed surfaces of the positive electrode current collector 21A. Thus, the positive electrode 21 is fabricated.

The negative electrode active material layers 22B are formed on the respective two opposed surfaces of the negative electrode current collector 22A by a procedure similar to the fabrication procedure of the negative electrode described above to thereby fabricate the negative electrode 22. In this case, a procedure similar to the fabrication procedure of the negative electrode of the first embodiment may be used or a procedure similar to the fabrication procedure of the negative electrode of the second embodiment may be used.

The electrolyte salt is put into a solvent. The electrolyte salt is thereby dispersed or dissolved in the solvent. As a result, the electrolytic solution is prepared.

First, the positive electrode lead 31 is coupled to the positive electrode current collector 21A of the positive electrode 21 by a method such as a welding method, and the negative electrode lead 32 is coupled to the negative electrode current collector 22A of the negative electrode 22 by a method such as a welding method.

Thereafter, the positive electrode 21 and the negative electrode 22 are stacked on each other with the separator 23 interposed therebetween, following which the stack of the positive electrode 21, the negative electrode 22, and the separator 23 is wound to thereby fabricate a wound body. The wound body has a configuration similar to that of the battery device 20 except that the positive electrode 21, the negative electrode 22, and the separator 23 are each not impregnated with the electrolytic solution. Thereafter, the wound body is pressed by means of, for example, a pressing machine to thereby shape the wound body into an elongated shape.

Thereafter, the wound body is placed inside the depression part 10U, following which the outer package film 10 (the fusion-bonding layer/the metal layer/the surface protective layer) is folded to thereby cause portions of the outer package film 10 to be opposed to each other. Thereafter, outer edge parts of two sides of the outer package film 10 (the fusion-bonding layer) opposed to each other are bonded to each other by a method such as a thermal-fusion-bonding method to thereby allow the wound body to be contained in the outer package film 10 having the pouch shape.

Lastly, the electrolytic solution is injected into the outer package film 10 having the pouch shape, following which outer edge parts of the remaining one side of the outer package film 10 (the fusion-bonding layer) are bonded to each other by a method such as a thermal-fusion-bonding method. In this case, the sealing film 41 is interposed between the outer package film 10 and the positive electrode lead 31, and the sealing film 42 is interposed between the outer package film 10 and the negative electrode lead 32. The wound body is thereby impregnated with the electrolytic solution. Thus, the battery device 20 that is a wound electrode body is fabricated, and the battery device 20 is sealed in the outer package film 10 having the pouch shape. As a result, the secondary battery is assembled.

The secondary battery after being assembled is charged and discharged. Various conditions including, for example, an environmental temperature, the number of times of charging and discharging (the number of cycles), and charging and discharging conditions may be set as desired. As a result, a film is formed on the surface of each of the positive electrode 21 and the negative electrode 22, and the state of the secondary battery is electrochemically stabilized. The secondary battery is thus completed.

The secondary battery includes the negative electrode 22 having a configuration similar to that of the negative electrode described above. Thus, an increase in the electric resistance and the decomposition of the electrolytic solution are suppressed while the ion conductivity of lithium is secured. Accordingly, it is possible to achieve a superior cyclability characteristic and a superior electric resistance characteristic.

Further, the secondary battery may include a lithium-ion secondary battery. This makes it possible to obtain a sufficient battery capacity stably through the use of insertion and extraction of lithium. Accordingly, it is possible to achieve higher effects.

Other action and effects of the secondary battery are similar to those of the negative electrode described above.

The configuration of the secondary battery described herein is appropriately modifiable including as described below. Note that any two or more of the following series of modifications may be combined with each other.

In an embodiment, the negative electrode does not include the covering part 121Y. Thus, the inorganic metal salt and the organic fiber compound are each dispersed in the negative electrode active material layer 120. In the second embodiment, the negative electrode (negative electrode active material particle 121) includes the covering part 121Y. Thus, the inorganic metal salt and the organic fiber compound are each localized on the surface of the center part 121X in the negative electrode active material layer 120.

However, the configuration of the negative electrode of the first embodiment and the configuration of the negative electrode of the second embodiment may be combined with each other. Specifically, the negative electrode active material layer 120 may include the inorganic metal salt and the organic fiber compound together with the negative electrode active material particles 121 (the center part 121X and the covering part 121Y). That is, in the negative electrode active material layer 120, the inorganic metal salt and the organic fiber compound may each be localized on the surface of the center part 121X, and also the inorganic metal salt and the organic fiber compound may each be dispersed around the negative electrode active material particles 121.

In this case also, the use of the inorganic metal salt and the organic fiber compound suppresses each of an increase in the electric resistance and the decomposition of the electrolytic solution while securing the ion conductivity of lithium, and similar effects are therefore obtainable.

The separator 23, which is a porous film, is used. However, although not specifically illustrated here, a separator of a stacked type including a polymer compound layer may be used.

Specifically, the separator of the stacked type includes a porous film having two opposed surfaces and the polymer compound layer disposed on one of or each of the two opposed surfaces of the porous film. A reason for this is that adherence of the separator to each of the positive electrode 21 and the negative electrode 22 improves, which suppresses occurrence of misalignment (winding displacement) of the battery device 20. This suppresses the swelling of the secondary battery even if, for example, the decomposition reaction of the electrolytic solution occurs. The polymer compound layer includes a polymer compound such as polyvinylidene difluoride. A reason for this is that the polymer compound such as polyvinylidene difluoride has superior physical strength and is electrochemically stable.

Note that the porous film, the polymer compound layer, or both may each include one or more kinds of insulating particles. A reason for this is that the insulating particles dissipate heat upon heat generation by the secondary battery, thus improving safety or heat resistance of the secondary battery. The insulating particles include one or more of materials including, without limitation, an inorganic material and a resin material. Specific examples of the inorganic material include aluminum oxide, aluminum nitride, boehmite, silicon oxide, titanium oxide, magnesium oxide, and zirconium oxide. Specific examples of the resin material include acrylic resin and styrene resin.

In a case of fabricating the separator of the stacked type, a precursor solution including, without limitation, the polymer compound and a solvent is prepared, following which the precursor solution is applied on one of or each of the two opposed surfaces of the porous film. In this case, insulating particles may be added to the precursor solution on an as-needed basis.

In the case where the separator of the stacked type is used also, lithium ions are movable between the positive electrode 21 and the negative electrode 22, and similar effects are therefore obtainable. In this case, particularly, the safety of the secondary battery is improved as described above. Accordingly, it is possible to achieve higher effects.

The electrolytic solution, which is a liquid electrolyte, is used. However, although not specifically illustrated here, an electrolyte layer that is a gel electrolyte may be used.

In the battery device 20 including the electrolyte layer, the positive electrode 21 and the negative electrode 22 are stacked on each other with the separator 23 and the electrolyte layer interposed therebetween, and the stack of the positive electrode 21, the negative electrode 22, the separator 23, and the electrolyte layer is wound. The electrolyte layer is interposed between the positive electrode 21 and the separator 23, and between the negative electrode 22 and the separator 23.

Specifically, the electrolyte layer includes a polymer compound together with the electrolytic solution. The electrolytic solution is held by the polymer compound. A reason for this is that liquid leakage of the electrolytic solution is prevented. The configuration of the electrolytic solution is as described above. The polymer compound includes, for example, polyvinylidene difluoride. In a case of forming the electrolyte layer, a precursor solution including, for example, the electrolytic solution, the polymer compound, and a solvent is prepared, following which the precursor solution is applied on one side or both sides of the positive electrode 21 and on one side or both sides of the negative electrode 22.

In the case where the electrolyte layer is used also, lithium ions are movable between the positive electrode 21 and the negative electrode 22 via the electrolyte layer, and similar effects are therefore obtainable. In this case, particularly, the liquid leakage of the electrolytic solution is prevented as described above. Accordingly, it is possible to achieve higher effects.

Applications (application examples) of the secondary battery are not particularly limited. The secondary battery used as a power source may serve as a main power source or an auxiliary power source of, for example, electronic equipment and an electric vehicle. The main power source is preferentially used regardless of the presence of any other power source. The auxiliary power source is used in place of the main power source, or is switched from the main power source.

Specific examples of the applications of the secondary battery include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include home battery systems or industrial battery systems for accumulation of electric power for a situation such as emergency. The above-described applications may each use one secondary battery, or may each use multiple secondary batteries.

The battery packs may each include a single battery, or may each include an assembled battery. The electric vehicle is a vehicle that operates (travels) using the secondary battery as a driving power source, and may be a hybrid automobile that is additionally provided with a driving source other than the secondary battery. In an electric power storage system for home use, electric power accumulated in the secondary battery which is an electric power storage source may be utilized for using, for example, home appliances.

An application example of the secondary battery will now be described in detail. The configuration of the application example described below is merely an example, and is appropriately modifiable.

FIG. 5 illustrates a block configuration of a battery pack. The battery pack described here is a battery pack (what is called a soft pack) including one secondary battery, and is to be mounted on, for example, electronic equipment typified by a smartphone.

As illustrated in FIG. 5, the battery pack includes an electric power source 51 and a circuit board 52. The circuit board 52 is coupled to the electric power source 51 and includes a positive electrode terminal 53, a negative electrode terminal 54, and a temperature detection terminal 55.

The electric power source 51 includes one secondary battery. The secondary battery has a positive electrode lead coupled to the positive electrode terminal 53 and a negative electrode lead coupled to the negative electrode terminal 54. The electric power source 51 is couplable to outside via the positive electrode terminal 53 and the negative electrode terminal 54, and is thus chargeable and dischargeable. The circuit board 52 includes a controller 56, a switch 57, a thermosensitive resistive device (a PTC device) 58, and a temperature detector 59. However, the PTC device 58 may be omitted.

The controller 56 includes, for example, a central processing unit (CPU) and a memory and controls an overall operation of the battery pack. The controller 56 detects and controls a use state of the electric power source 51 on an as-needed basis.

If a voltage of the electric power source 51 (the secondary battery) reaches an overcharge detection voltage or an overdischarge detection voltage, the controller 56 turns off the switch 57. This prevents a charging current from flowing into a current path of the electric power source 51. The overcharge detection voltage is not particularly limited and is specifically 4.2 V±0.05 V. The overdischarge detection voltage is not particularly limited and is specifically 2.4 V±0.1 V.

The switch 57 includes, for example, a charge control switch, a discharge control switch, a charging diode, and a discharging diode. The switch 57 performs switching between coupling and decoupling between the electric power source 51 and external equipment in accordance with an instruction from the controller 56. The switch 57 includes, for example, a metal-oxide-semiconductor field-effect transistor (MOSFET). The charging and discharging currents are detected based on an ON-resistance of the switch 57.

The temperature detector 59 includes a temperature detection device such as a thermistor. The temperature detector 59 measures a temperature of the electric power source 51 using the temperature detection terminal 55 and outputs a result of the temperature measurement to the controller 56. The result of the temperature measurement to be obtained by the temperature detector 59 is used, for example, in a case where the controller 56 performs charge and discharge control upon abnormal heat generation or in a case where the controller 56 performs a correction process upon calculating a remaining capacity.

### EXAMPLES

A description is given of Examples of the present technology according to an embodiment.

### Examples 1 to 8 and Comparative Examples 1 to 3

Secondary batteries were fabricated, following which the secondary batteries were each evaluated for a battery characteristic as described below.

### [Fabrication of Secondary Battery]

The lithium-ion secondary batteries of the laminated-film type illustrated in FIGS. 3 and 4 were fabricated in accordance with the following procedure.

### (Fabrication of Positive Electrode)

First, 95 parts by mass of the positive electrode active material (LiCoO₂ that was the lithium-containing compound (an oxide)), 3 parts by mass of the positive electrode binder (polyvinylidene difluoride), and 2 parts by mass of the positive electrode conductor (Ketjen black) were mixed with each other to thereby obtain a positive electrode mixture. Thereafter, the positive electrode mixture was put into a solvent (N-methyl-2-pyrrolidone that was an organic solvent), following which the solvent was stirred to thereby prepare a positive electrode mixture slurry in a paste form.

Thereafter, the positive electrode mixture slurry was applied on the two opposed surfaces of the positive electrode current collector 21A (an aluminum foil having a thickness of 10 μm) by means of a coating apparatus, following which the applied positive electrode mixture slurry was dried to thereby form the positive electrode active material layers 21B. Lastly, the positive electrode active material layers 21B were compression-molded by means of a roll pressing machine, following which the positive electrode current collector 21A on which the positive electrode active material layers 21B were formed was cut into a band shape (having a width of 70 mm and a length of 800 mm). The positive electrode 21 was thus fabricated.

### (Fabrication of Negative Electrode)

Here, the negative electrodes 22 having two kinds of configurations (a dispersion type and a covering type) were fabricated.

In fabricating the negative electrode 22 of the dispersion-type, first, 65.4 parts by mass of the negative electrode active material (mesocarbon microbead (MCMB) that was a carbon material), 30 parts by mass of another negative electrode active material (a metal-based material), 3 parts by mass of the negative electrode binder (polyvinylidene difluoride), 1 part by mass of the negative electrode conductor (carbon nanotube), 0.3 parts by mass of the inorganic metal salt, and 0.3 parts by mass of the organic fiber compound were mixed with each other to thereby form a negative electrode mixture.

Used as the metal-based material were silicon oxide (SiO) that was a compound of silicon, a simple substance of silicon (Si), and silicon titanium alloy (SiTi_{0.01}) that was an alloy of silicon. Used as the inorganic metal salt were lithium fluoride (LiF) and lithium carbonate (Li₂CO₃). Used as the organic fiber compound were cellulose, chitin, and chitosan.

In obtaining the negative electrode mixture, the metal-based material was substituted with the carbon material on an as-needed basis to use only the carbon material and not use the metal-based material as the negative electrode active material.

Thereafter, the negative electrode mixture was put into a solvent (N-methyl-2-pyrrolidone that was an organic solvent), following which the solvent was stirred using a planetary centrifugal mixer to thereby prepare a negative electrode mixture slurry in a paste form. Thereafter, the negative electrode mixture slurry was applied on the two opposed surfaces of the negative electrode current collector 22A (a copper foil having a thickness of 8 μm) by means of a coating apparatus, following which the applied negative electrode mixture slurry was dried by hot air to thereby form the negative electrode active material layers 22B.

Lastly, the negative electrode active material layers 22B were compression-molded by means of a roll pressing machine, following which the negative electrode current collector 22A on which the negative electrode active material layers 22B were formed was cut into a band shape (having a width of 72 mm and a length of 810 mm). The negative electrode 22 of the dispersion type was thus fabricated.

In fabricating the negative electrode 22 of the covering type, first, 98 parts by mass of the powdered metal-based material (silicon oxide (SiO) that was a compound of silicon), 1 part by mass of the inorganic metal salt (lithium fluoride), 1 part by mass of the organic fiber compound (cellulose) were mixed with each other to thereby obtain a mixture.

Thereafter, the mixture was put into a solvent (pure water that was an aqueous solvent), following which the solvent was stirred to thereby prepare a mixed solution. Thereafter, the mixed solution was sprayed using a spray dryer, following which the sprayed matter was dried. This formed the covering part 121Y including the inorganic metal salt and the organic fiber compound on the surface of the center part 121X including the metal-based material. Thus, the negative electrode active material particles 121 were obtained.

Thereafter, 66 parts by mass of the MCMB that was a carbon material, 30 parts by mass of the negative electrode active material particles 121 (the center part 121X and the covering part 121Y), 3 parts by mass of the negative electrode binder (polyvinylidene difluoride), and 1 part by mass of the negative electrode conductor (carbon nanotube) were mixed with each other to thereby obtain a negative electrode mixture. Thereafter, the negative electrode mixture was put into a solvent (N-methyl-2-pyrrolidone that was an organic solvent), following which the solvent was stirred using a planetary centrifugal mixer to thereby prepare a negative electrode mixture slurry in a paste form.

Thereafter, by a procedure similar to that in a case where the negative electrode 22 of the dispersion type was fabricated, the negative electrode active material layers 22B were formed and compression-molded, following which the negative electrode current collector 22A on which the negative electrode active material layers 22B were formed was cut into a band shape. The negative electrode 22 of the covering type was thus fabricated.

Note that, for comparison, the negative electrode 22 was fabricated by a similar procedure except that neither the inorganic metal salt nor the organic fiber compound was used. In this case, the inorganic metal salt and the organic fiber compound were both substituted with the negative electrode active material (the metal-based material).

Additionally, for comparison, the negative electrode 22 was fabricated by a similar procedure except that only one of the inorganic metal salt or the organic fiber compound was used. In this case, one of the inorganic metal salt or the organic fiber compound was substituted with the negative electrode active material (the metal-based material).

### (Preparation of Electrolytic Solution)

The electrolyte salt (LiPF₆ that was a lithium salt) was added to a solvent (ethylene carbonate (EC) that was a cyclic carbonic acid ester and ethyl methyl carbonate (EMC) that was a chain ethylene carbonate), following which the solvent was stirred. In this case, a mixture ratio (a mass ratio) between the cyclic carbonic acid ester and the chain carbonic acid ester in the solvent was set to 50:50, and a content of the electrolyte salt was set to 1 mol/dm³ (=1 mol/l) with respect to the solvent. In this manner, the electrolytic solution was prepared.

### (Assembly of Secondary Battery)

First, the positive electrode lead 31 including aluminum was welded to the positive electrode current collector 21A of the positive electrode 21, and the negative electrode lead 32 including copper was welded to the negative electrode current collector 22A of the negative electrode 22.

Thereafter, the positive electrode 21 and the negative electrode 22 were stacked on each other with the separator 23 (a fine porous polyethylene film having a thickness of 25 μm) interposed therebetween, following which the stack of the positive electrode 21, the negative electrode 22, and the separator 23 was wound to thereby fabricate a wound body. Thereafter, the wound body was pressed by means of a pressing machine, and was thereby shaped into an elongated shape.

Thereafter, the outer package film 10 was folded in such a manner as to sandwich the wound body contained inside the depression part 10U. As the outer package film 10, an aluminum laminated film was used in which a fusion-bonding layer (a polypropylene film having a thickness of 30 μm), a metal layer (an aluminum foil having a thickness of 40 μm), and a surface protective layer (a nylon film having a thickness of 25 μm) were stacked in this order from an inner side. Thereafter, the outer edge parts of two sides of the outer package film 10 (the fusion-bonding layer) were thermal-fusion-bonded to each other to thereby allow the wound body to be contained inside the outer package film 10 having the pouch shape.

Lastly, the electrolytic solution was injected into the outer package film having the pouch shape, and thereafter, the outer edge parts of the remaining one side of the outer package film 10 (the fusion-bonding layer) were thermal-fusion-bonded to each other in a reduced-pressure environment. In this case, the sealing film 41 (a polypropylene film having a thickness of 5 μm) was interposed between the outer package film 10 and the positive electrode lead 31, and the sealing film 42 (a polypropylene film having a thickness of 5 μm) was interposed between the outer package film 10 and the negative electrode lead 32. In this manner, the wound body was impregnated with the electrolytic solution. As a result, the battery device 20, which is the wound electrode body, was fabricated. Accordingly, the battery device was sealed in the outer package film 10. As a result, the secondary battery was assembled.

### (Stabilization of Secondary Battery)

The secondary battery was charged and discharged for one cycle in an ambient-temperature environment (at a temperature of 23° C.). Upon the charging, the secondary battery was charged with a constant current of 0.2 C until a voltage reached 4.4 V, and was thereafter charged with a constant voltage of 4.4 V until a current reached 0.025 C. Upon the discharging, the secondary battery was discharged with a constant current of 0.5 C until the voltage reached 3.0 V. Note that 0.2 C was a value of a current that caused a battery capacity (a theoretical capacity) to be completely discharged in 5 hours. Similarly, 0.025 C was a value of a current that caused a battery capacity to be completely discharged in 40 hours, and C was a value of a current that caused the battery capacity to be completely discharged in 2 hours. As a result, the secondary battery of the laminated-film type was completed.

Evaluation of the secondary batteries for their battery characteristics (the cyclability characteristic and the electric resistance characteristic) revealed the results presented in Table 1. Here, two kinds of cyclability characteristics (an ambient-temperature cyclability characteristic and a high-temperature cyclability characteristic) were examined.

### (Ambient-Temperature Cyclability Characteristic)

First, the secondary battery was charged and discharged in an ambient-temperature environment (at a temperature of 23° C.) to thereby measure the discharge capacity (an initial cycle discharge capacity). Thereafter, the secondary battery was repeatedly charged and discharged in the same environment until the number of cycles reached 500 to thereby measure the discharge capacity (a 500th-cycle discharge capacity). Lastly, an ambient-temperature capacity retention rate that was an index for evaluating the ambient-temperature cyclability characteristic was calculated based on the following calculation expression: ambient-temperature capacity retention rate (%)=(500th-cycle discharge capacity/initial cycle discharge capacity)×100. Note that charging and discharging conditions were similar to those in the case of stabilizing the secondary battery described above.

### (High-Temperature Cyclability Characteristic)

A high-temperature capacity retention rate (%) that was an index for evaluating the high-temperature cyclability characteristic was calculated by a procedure similar to that of the case in which the ambient-temperature cyclability characteristic was examined except that the secondary battery was charged and discharged in a high-temperature environment (at a temperature of 60° C.).

### (Electric Resistance Characteristic)

First, the secondary battery was charged and discharged in a high-temperature environment (at a temperature of 60° C.). In this case, upon the discharging, the secondary battery that had a state of charge (SOC) of 50% was discharged at a current of 5 C for 10 seconds to thereby measure an amount of voltage drop of the secondary battery after 10 seconds from the start of the discharging. Thereafter, the electric resistance (an initial cycle electric resistance) was calculated based on the amount of voltage drop. Note that 5 C was a value of a current that caused the battery capacity to be completely discharged in 0.2 hours.

Thereafter, the secondary battery was repeatedly charged and discharged in the same environment until the number of cycles reached 500. In this case, upon the 500th cycle of discharging, the electric resistance (500th-cycle electric resistance) was calculated by a procedure similar to that of the case in which the initial cycle electric resistance was calculated as described above.

Lastly, a high-temperature resistance increase rate that was an index for evaluating the electric resistance characteristic was calculated based on the following calculation expression: high-temperature resistance increase rate (%)=(500th-cycle electric resistance/initial cycle electric resistance)×100.

Note that values of the ambient-temperature capacity retention rate given in Table 1 were values normalized with respect to the value of the ambient-temperature capacity retention rate of Comparative example 1 that includes neither the inorganic metal salt nor the organic fiber compound assumed as 1.000. Similarly, values of the high-temperature capacity retention rate were values normalized with respect to the value of the high-temperature capacity retention rate of Comparative example 1 assumed as 1.000, and the values of the high-temperature resistance increase rate were values normalized with respect to the value of the high-temperature resistance increase rate of Comparative example 1 assumed as 1.000. In this case, the values of the ambient-temperature capacity retention rate, the high-temperature capacity retention rate, and the high-temperature resistance increase rate were values rounded off to three decimal places.

TABLE 1

| | Negative electrode | | | | | | | |
|---|---|---|---|---|---|---|---|---|
| | | Negative electrode | | | | Ambient- | High- | High- |
| | | active material | | | | temperature | temperature | temperature |
| | | | Metal- | | Organic | capacity | capacity | resistance |
| | | Carbon | based | Inorganic | fiber | retention rate | retention rate | increase rate |
| | Configuration | material | material | metal salt | compound | (%) | (%) | (%) |
| Example 1 | Dispersion | MCMB | SiO | LiF | Cellulose | 1.113 | 1.037 | 0.929 |
| Example 2 | type | MCMB | SiO | LiF | Chitin | 1.100 | 1.028 | 0.934 |
| Example 3 | | MCMB | SiO | LiF | Chitosan | 1.096 | 1.027 | 0.931 |
| Example 4 | | MCMB | SiO | Li₂CO₃ | Cellulose | 1.117 | 1.041 | 0.916 |
| Example 5 | | MCMB | Si | LiF | Cellulose | 1.088 | 1.023 | 0.951 |
| Example 6 | | MCMB | SiTi_{0.01} | LiF | Cellulose | 1.094 | 1.025 | 0.942 |
| Example 7 | | MCMB | — | LiF | Cellulose | 1.188 | 1.093 | 0.907 |
| Example 8 | Covering type | MCMB | SiO | LiF | Cellulose | 1.125 | 1.040 | 0.918 |
| Comparative | Dispersion | MCMB | SiO | — | — | 1.000 | 1.000 | 1.000 |
| example 1 | type | | | | | | | |
| Comparative | | MCMB | SiO | LiF | — | 0.993 | 0.999 | 0.996 |
| example 2 | | | | | | | | |
| Comparative | | MCMB | SiO | — | Cellulose | 1.025 | 0.953 | 1.018 |
| example 3 | | | | | | | | |

As indicated in Table 1, the ambient-temperature capacity retention rate, the high-temperature capacity retention rate, and the high-temperature resistance increase rate each varied greatly depending on the configuration of the negative electrode 22. Hereinafter, each of the ambient-temperature capacity retention rate, the high-temperature capacity retention rate, and the high-temperature resistance increase rate of Comparative example 1 that included neither the inorganic metal salt nor the organic fiber compound served as a comparative reference.

In a case where only the inorganic metal salt was included (Comparative example 2), each of the ambient-temperature capacity retention rate and the high-temperature capacity retention rate decreased while the high-temperature resistance increase rate decreased. In a case where only the organic fiber compound was included (Comparative example 3), the high-temperature capacity retention rate decreased, and the high-temperature resistance increase rate increased while the ambient-temperature capacity retention rate increased.

In contrast, in a case where both the inorganic metal salt and the organic fiber compound were included (Examples 1 to 8), regardless of the configuration of the negative electrode 22 (the dispersion type or the covering type), the high-temperature resistance increase rate decreased, and each of the ambient-temperature capacity retention rate and the high-temperature capacity retention rate increased. In this case, particularly, when the configuration of the negative electrode 22 was of the covering type, each of the ambient-temperature capacity retention rate and the high-temperature capacity retention rate increased more, and the high-temperature resistance increase rate decreased more.

### Examples 9 to 12

As indicated in Table 2, secondary batteries were fabricated by a procedure similar to that of Example 1 except that each of the composition of the electrolyte salt and the composition of the solvent was varied, following which the secondary batteries were each evaluated for a battery characteristic.

In varying the composition of the electrolyte salt, a portion of hexafluorophosphate was substituted with another lithium salt. Used as the other lithium salt were lithium monofluorophosphate (Li₂PFO₃) and lithium difluorophosphate (LiPF₂O₂). In this case, the mixture ratio (mass ratio) of the electrolyte salt between the lithium hexafluorophosphate and the other lithium salt was set to 50:50.

In varying the composition of the solvent, the chain carbonic acid ester was substituted with the chain carboxylic acid ester. Used as the chain carboxylic acid ester were ethyl propionate (EtPr) and propyl propionate (PrPr).

TABLE 2

| | | | | | Ambient- | High- | High- |
|---|---|---|---|---|---|---|---|
| | Negative electrode | | | | temperature | temperature | temperature |
| | | Organic | Electrolytic solution | | capacity | capacity | resistance |
| | Inorganic | fiber | | Electrolyte | retention rate | retention rate | increase rate |
| | metal salt | compound | Solvent | salt | (%) | (%) | (%) |
| Example 1 | LiF | Cellulose | EC + EMC | LiPF₆ | 1.113 | 1.037 | 0.929 |
| Example 9 | LiF | Cellulose | EC + EMC | LiPF₆ + | 1.118 | 1.045 | 0.915 |
| | | | | Li₂PFO₃ | | | |
| Example 10 | LiF | Cellulose | EC + EMC | LiPF₆ + | 1.119 | 1.047 | 0.912 |
| | | | | LiPF₂O₂ | | | |
| Example 11 | LiF | Cellulose | EC + EtPr | LiPF₆ | 1.131 | 1.044 | 0.916 |
| Example 12 | LiF | Cellulose | EC + PrPr | LiPF₆ | 1.125 | 1.041 | 0.920 |

As indicated in Table 2, in a case where the electrolyte salt included another lithium salt (lithium monofluorophosphate or lithium difluorophosphate) (Examples 9 and 10), each of the ambient-temperature capacity retention rate and the high-temperature capacity retention rate increased more, and the high-temperature resistance increase rate decreased more compared with a case where the electrolyte salt did not include the other lithium salt (Example 1).

Furthermore, in a case where the solvent included the chain carboxylic acid ester (Examples 11 and 12), each of the ambient-temperature capacity retention rate and the high-temperature capacity retention rate increased more, and the high-temperature resistance increase rate decreased more compared with a case where the solvent did not include the chain carboxylic acid ester (Example 1).

Based upon the results presented in Tables 1 and 2, in the case where the negative electrode 22 included the inorganic metal salt and the organic fiber compound, each of the ambient-temperature cyclability characteristic, the high-temperature cyclability characteristic, and the electric resistance characteristic improved. The secondary battery therefore achieved a superior cyclability characteristic and a superior electric resistance characteristic.

Although the present technology has been described herein with reference to one or more embodiments including Examples, the configuration of the present technology is not limited thereto, and is therefore modifiable in a variety of suitable ways.

The description has been given of the case where the secondary battery has a battery structure of the laminated-film type. However, the battery structure of the secondary battery is not particularly limited in kind. Specifically, the battery structure may be, for example, a cylindrical type, a prismatic type, a coin type, or a button type.

Further, the description has been given of the case where the battery device has a device structure of a wound type. However, the device structure of the battery device is not particularly limited in kind. Specifically, the device structure may be, for example, a stacked type in which the electrodes (the positive electrode and the negative electrode) are stacked on each other, or a zigzag folded type in which the electrodes are folded in a zigzag manner, or any other structure.

Further, although the description has been given of the case where the electrode reactant is lithium, the electrode reactant is not particularly limited in kind. Specifically, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited to those described herein. Accordingly, the present technology may achieve any other suitable effect.

It should be understood that various changes and modifications to the embodiments described herein will be apparent to those skilled in the art. Such changes and modifications can be made without departing from the spirit and scope of the present subject matter and without diminishing it intended advantages. It is therefore intended that such changes and modifications be covered by the appended claims.

1. A secondary battery comprising:
a positive electrode;
a negative electrode; and
an electrolytic solution, wherein
the negative electrode includes an inorganic metal salt and an organic fiber compound.

2. The secondary battery according to claim 1, wherein
the inorganic metal salt includes lithium fluoride, lithium carbonate, or both, and
the organic fiber compound includes at least one of cellulose, chitin, or chitosan.

3. The secondary battery according to claim 1, wherein
the negative electrode includes a negative electrode active material layer, and
the negative electrode active material layer includes a negative electrode active material, the inorganic metal salt, and the organic fiber compound.

4. The secondary battery according to claim 1, wherein
the negative electrode includes a negative electrode active material, and
the negative electrode active material includes
a center part configured to allow insertion and extraction of an electrode reactant, and
a covering part covering a surface of the center part and including the inorganic metal salt and the organic fiber compound.

5. The secondary battery according to claim 1, wherein the electrolytic solution includes lithium monofluorophosphate, lithium difluorophosphate, or both.

6. The secondary battery according to claim 1, wherein the electrolytic solution includes a chain carboxylic acid ester.

7. The secondary battery according to claim 1, wherein the secondary battery comprises a lithium-ion secondary battery.

8. A negative electrode for a secondary battery, the negative electrode comprising an inorganic metal salt and an organic fiber compound.
